(19) United States
(12) Patent Application Publication
(10) Pub. No.: US 2026/0224066 A1
(43) Pub. Date: Aug. 6, 2026

(54) A BREWER WITH A SENSOR, A BREWER KIT AND A METHOD FOR CONTROLLING A BREWER

(71) Applicant: Aarke AB, Stockholm (SE)

(72) Inventors: Melker MAGNERIUS, Stockholm (SE); Rasmus BAUDTLER, Stockholm (SE)

(73) Assignee: Aarke AB, Stockholm (SE)

(21) Appl. No.: 19/150,304

(22) PCT Filed: Jan. 24, 2024
(86) PCT No.: PCT/EP2024/051634

§ 371 Date: Jul. 23, 2025

(30) Foreign Application Priority Data
Jan. 26, 2023 (SE) 2350073-9

(51) Int. Cl. A47J 31/52; A47J 31/44

(52) U.S. Cl. CPC A47J 31/525; A47J 31/4435

(57) ABSTRACT

A brewer for preparing a beverage, the brewer comprising a receptacle receiving portion configured to receive a beverage receptacle, and a receptacle-type sensor. The receptacle-type sensor is configured to detect a presence of an identification feature of a beverage receptacle received by the receptacle receiving portion. The brewer is configured to adapt its operation upon such detection. A kit with such a brewer and at least one beverage receptacle, which may comprise an identification feature, and a method for controlling a brewer.

### PRIORITY

This patent application is an International PCT patent application, which claims priority to Swedish patent application no. 2350073-9 with the title “A BREWER WITH A SENSOR, A BREWER KIT AND A METHOD FOR CONTROLLING A BREWER”, filed on Jan. 26, 2023.

### CO-EXISTING RELATED PATENT APPLICATION

This PCT patent application is filed concurrently with the patent applications as per below and filed by the same applicant. Details on specific issues in these patent applications are to be considered as incorporated into each one of the other related patent applications.

The related PCT patent applications are titled:
A coffee bean grinder
A brewer for preparing a beverage

### TECHNICAL FIELD

The present disclosure generally pertains to a brewer for preparing a beverage and a method of controlling such a brewer, and more particularly to such a brewer comprising means for identifying a beverage receptacle as well as a kit comprising such a brewer and a beverage receptacle.

### BACKGROUND ART

Brewers for preparing beverages such as coffee or tea are well known in the prior art. A brewer is commonly used together with a beverage receptacle into which a prepared beverage is dispensed from the brewer. Examples of receptacle types which may be used are glass jugs and thermally insulated jugs.

### SUMMARY OF THE INVENTION

A brewer may be compatible with more than one type of beverage receptacle. Different beverage receptacles may however require different interactions with the brewer. For example, some receptacles are suitable to be heated in order to keep a beverage within them warm, and others may be configured in a way that makes them unsuitable to be heated. It is thereby desirable that the brewer may adapt its operation depending on which receptacle is used.

It is in view of the above mentioned issue and others that the embodiments of the present invention have been made. The present disclosure recognizes the fact that brewers in the prior art are limited in regards of being able to provide suitable treatment of different receptacles in an automatic, convenient and reliable manner. The brewer of the invention is provided with the ability to automatically identify a beverage receptacle inserted into the brewer and adapt its operation based in the identity of that receptacle.

According to a first aspect of the present disclosure, there is provided a brewer for preparing a beverage. The brewer comprises a receptacle receiving portion configured to receive a beverage receptacle. The brewer further comprises a receptacle-type sensor configured to detect a presence of an identification feature of a beverage receptacle when that beverage receptacle is in a position of being received by the receptacle receiving portion. The brewer is configured to adapt its operation upon such detection of an identification feature.

The receptacle receiving portion is configured such that when a beverage receptacle is placed correctly upon it for brewing (in other words, is received), the position where prepared beverage exits (e.g. through a beverage dispensing unit) during a brew cycle is located, in relation to the beverage receptacle, such that the beverage enters the receptacle after being prepared by the brewer. The receptacle receiving portion may be located on a supporting portion of the brewer extending from a water tank of the brewer. The receptacle receiving portion may comprise a substantially flat surface onto which a beverage receptacle is to be placed. The flat surface may be a heating plate. There may be a ridge and/or a recess and/or a visual marking which shows or guides a user to place the receptacle correctly on the receptacle receiving portion.

The receptacle-type sensor is configured to indirectly detect the presence of a beverage receptacle on the receptacle receiving portion as it detects an identification feature of that beverage receptacle within a certain predetermined area.

The receptacle-type sensor may be a proximity sensor. Proximity sensors detect when an object, herein an identification feature, is within a proximity area (sensing area) where the sensor is configured to operate. It does not necessarily detect the distance between the sensor and the object or the position of the object within the proximity area. It may for example be an inductive sensor, a capacitive sensor, an ultrasonic sensor, an IR sensor, a magnetic sensor, or an optical sensor. It may comprise an electromechanical switch that physically interacts with an identification feature being a geometric identification feature (a shape).

The proximity sensor may be operatively coupled to a control unit that reacts when the identification feature is detected within the proximity area. The control unit may for example be an on-off switch in the brewer, which acts to turn on or off a certain function of the brewer. A switch may be integral with the sensor, the sensor then being a so-called proximity switch.

The proximity area may be configured based on the expected location (optimal position) of an identification feature when a beverage receptacle is correctly received. The proximity area may be configured such that the identification feature to be detected by a proximity sensor is detected only when it is in a very specific position indicating a received beverage receptacle, and moving the receptacle a short distance (such as 0.5, 1 or 2 cm) from its optimal position results in the identification feature not being detected. Alternatively, the proximity area is greater and the identification feature is detected when up to for example 5 or 10 cm from its optimal position. The proximity area may be the area within for example 0.5-10 cm, such as 0.5-5 or 0.5-2 cm, of the proximity sensor.

The receptacle-type sensor may be a distance sensor. Such a sensor determines a distance to, or specific position of, an object (the identification feature). The distance sensor may be configured for a continuous or stepwise detection of the distance to the identification feature. The term detect is in the context of distance sensors meant as the identification feature being determined to be positioned within a certain distance of the sensor. The distance sensor may for example be an ultrasonic sensor, an infrared distance sensor, or a laser distance sensor. The distance sensor may be a linear position sensor. The distance sensor may be a magnetic field sensor that determines the distance from an identification feature comprising a magnet by measuring a magnetic field surrounding the identification feature. The distance sensor may be an analogue input sensor that provides an analogue output proportional to the distance between the sensor and the identification feature. It may be an inductive analogue sensor that gives out a current or voltage signal which is proportional to the distance between the sensor and the identification feature (being for example a metal identification feature).

The distance sensor may be coupled to a control unit that is configured to react when the identification feature is determined to be within a certain distance from the sensor. The control unit may be an on-off switch in the brewer, which acts to turn on or off a certain function of the brewer (i.e. adapt its operation). The effect of such a setup is similar to that of a proximity sensor.

A suitable distance range from the distance sensor to the identification feature to result in an adapted operation may be 0.5-10 cm, such as 0.5-5 or 0.5-2 cm, depending on the location of the sensor in the brewer in relation to the optimal position of an identification feature in a receptacle intended to be used with the brewer.

A sensor that detects the presence of an identification feature and/or determines that its position is within a certain distance, may send a signal to a control unit of the brewer, which in turn controls the adaptation of an operation of the brewer based on that signal.

The identification of such an identification feature has several purposes. It can be used to detect when a beverage receptacle is suitably located (received) on the receptacle receiving portion for operations such as beverage brewing and heating of the receptacle. The brewer may be configured such that these operations may not be performed without such detection. It can also be used to determine what type of receptacle is received, through detection of different identification features associated with different types of receptacles. Different types of receptacles may be in need of different treatment by the brewer.

The brewer adapting its operation upon such detection may involve activating a certain brewing program suitable for the received receptacle, activating or deactivating a heating means for heating the receptacle, or activating or deactivating a flow of water from the brewer and/or of beverage into the receptacle. These are further discussed below.

An advantage of the present brewer is that the adaptation of operation is performed automatically by the brewer. There is no need for a user to manually adapt the operation of the brewer in order to fit a receptacle being used. Not only is this convenient, it may also be safer.

The brewer may comprise a heating means configured to heat a beverage receptacle received by the receptacle receiving portion. The heating means may be comprised in the receptacle receiving portion. It may be configured to be located under a received receptacle, such that it supports the receptacle and heats it from beneath. The brewer may be configured to adapt the operation of the heating means based on the detection of an identification feature. The brewer may be configured to only be able to activate the heating means when an identification feature is detected by a receptacle-type sensor of the brewer. In other words, the heating means may be configured to be active only when an identification feature is detected by a receptacle-type sensor of the brewer. The heating means is preferably configured such that it is automatically only turned on if an identification feature of a type being associated with a type of beverage receptacle that is suitable for heating is detected by a receptacle-type sensor. When such an identification feature is detected, the heating means may be turned on and kept on, until the identification feature is no longer detected or within a predetermined range. This way, the heating means may automatically be turned off when the beverage receptacle is removed from the brewer. The risk of overheating, burning or causing a fire is decreased. Energy usage may also be decreased.

The operation of the heating means may be adapted in other ways than being turned on and off by detection of an identification feature. A suitable heating program may be initiated, depending on a detection of a type of identification feature.

The heating level of the heating means may be adapted such that during a brew cycle, the heat is off or lower in the beginning, as there will only be a low amount of beverage in the receptacle, which may be burnt if heated too much. The heat may then be increased over time, as the receptacle is filled with beverage. After a brew cycle, when a beverage receptacle may be kept on the receiving portion in order to keep the beverage warm, the heat may be gradually decreased over time to not burn the beverage. It is also likely that the amount of beverage in the receptacle decreases over time, as it is consumed by a user, and requires less heat. When the receptacle is removed from the heating means, the receptacle-type sensor no longer detects an identification feature and the heating means may be turned off. When the receptacle is put back onto the receiving means, the identification feature is detected and the heat may be turned on again, to the same, or a higher, or a lower heating level as compared to the heating level at the point when the receptacle was removed. This may be adapted based on the length of time the receptacle was removed for.

Due to the features describes above, the brewer is suitable for use with at least two types of receptacles; a receptacle suitable to be heated and a receptacle unsuitable to be heated. An example is a non-thermally insulated glass carafe and a thermally insulated thermos jug, where only the glass carafe is suitable to be heated. Such a combination of receptacles may be used with the brewer, where for example only the receptacle suitable to be heated comprises an identification feature, or where the receptacles both comprise of identification features, but different types of identification features, which are distinguishable to receptacle-type sensor(s) of the brewer. The different types of identification features may be of different character or different versions of the same character (shape, magnet, material, etc.).

The brewer may be configured to adapt its operation and/or activate a brew program associated with a detected identification feature of a received beverage receptacle, e.g. upon the brewer being turned on or at initiation of a brew cycle or after initiation of a brew cycle (when the beverage is already being prepared). The brew program desired for an upcoming or ongoing brew cycle may differ depending on the type of beverage receptacle used. The identification feature may for example indicate that the receptacle is a mug that is smaller than certain other receptacles that may be used with the brewer, and that the whole volume of water present in the brewer should not be used in the upcoming (or ongoing) brew cycle, but only a predetermined amount of e.g. 2.5 dl (0.25 litres).

The brewer may comprise a water dispensing unit for dispensing water into a container for infusion material, such as a filter holder for a single or multiple use filters. Typically, water is led from a water tank of the brewer, through a delivery pipe, to a water dispensing unit that dispenses water into such a container. A means for controlling the flow of water exiting from said water dispensing unit may be present in the brewer that controls the flow rate of water from the water tank and through said delivery pipe. The means for controlling the flow of water may comprise a heating element. The means for controlling the flow of water may be configured to induce a flow of water from the water tank only when an identification feature is detected by a receptacle-type sensor. If the brewer is adapted (as further described below) only to allow flow of prepared beverage out from the infusion container when a receptacle is received (i.e. an identification feature is detected), the risk for overflowing the infusion container may be reduced by only inducing flow of water from the water tank when a receptacle is received.

The brewer may comprise a beverage dispensing unit, which facilitates a flow of prepared beverage from a container for infusion material (such as a filter holder) into a received receptacle. The beverage dispensing unit may be configured only to allow a flow of beverage from the container for infusion material to the receptacle when an identification feature is detected. In other words, the brewer may be configured to adapt its operation by opening a beverage dispensing unit such that prepared beverage is released only when a receptacle is received. A drip-stop function is thereby achieved. As mentioned above, this is suitably combined with the function that the flow of water out from the brewer (into the container for infusion material) is ceased when the release of prepared beverage is ceased. The flow of water out from the brewer may suitably be ceased before the release of prepared beverage is ceased. This way, overflow from the container for infusion material may be avoided.

The receptacle-type sensor may be configured to detect the presence of an identification feature being a magnet. It may be a magnetic field sensor. It may be a linear magnetic position sensor. The receptacle-type sensor may be configured to detect the orientation of a magnet. This way, the sensor may differentiate between at least two distinct types of beverage receptacles, wherein each receptacles comprises a magnet of different orientation. The sensor may for example be able to distinguish between: a receptacle with no magnet, a receptacle with a magnet, and a receptacle with a differently oriented magnet.

The receptacle-type sensor may be, or comprise, a Hall effect sensor (Hall sensor). Frequently, a Hall effect sensor is combined with a threshold detection means (here acting as a type of controlling unit) in order to act as a binary switch. A Hall effect switch turns on (or off) in the presence of a magnetic field and turns off when the magnet is removed. Such a sensor could thereby be used in combination with an identification feature being a magnet.

The receptacle-type sensor may be configured to detect the presence of an identification feature being defined by at least one of the shape and the material of the beverage receptacle. The shape of a receptacle may determine the way the receptacle physically interacts with a part of the brewer. The shape may be such that the physical interaction results in a switch being turned on in the brewer when the receptacle is received. The switch may be, or may be operatively coupled to, a controlling unit that controls the adaptation of an operation of the brewer. Said shape may be the shape of the lid of a beverage receptacle, the lid interacting with the brewer, for example with a beverage dispensing means of the brewer, when placed upon the receptacle receiving portion in a correct position for brewing. Such a shape may alternatively lead to an interaction with a switch that is pushed down or forward from the receptacle, by the receptacle, when the receptacle is placed in the received position.

The identification may comprise a mechanical rocker that is moved in different ways depending on the shape of the receptacle received and thereby interacts with the receptacle-type sensor in different ways depending on the receptacle type. The sensor may in this case be for example a potentiometer, rotary switch or a magnet sensor.

The identification feature may be essentially ring-shaped, cylinder-shaped or be of another rotationally symmetrical shape. The identification feature may be arranged to surround an opening of the receptacle through which beverage is to be introduced. The identification feature may be annular. The identification feature may be present in a lid of the receptacle.

The brewer may comprise a beverage dispensing unit, as mentioned above. The beverage dispensing unit may be configured to facilitate dispensing a prepared beverage into a beverage receptacle received by the receptacle receiving portion during a brewing cycle. The receptacle-type sensor may be located in the beverage dispensing unit. Alternatively, the sensor may be located at other parts of the brewer, such as in or on a water tank or in the receptacle receiving portion or in or on a supporting portion of the brewer. These areas may however be less optimal as the sensor may be exposed to heat, which a sensor may be sensitive to. The sensor being located in a beverage dispensing unit is also suitable if an identification feature is to be placed in an upper part of the receptacle, specifically the lid, as they come close when the receptacle is received.

In order to be able to distinguish between at least two types of beverage receptacles, where both contains an identification feature specific for that type of beverage receptacle, the brewer may comprise at least two receptacle-type sensors. Each sensor may then be configured to detect a presence of at least one type of identification feature unique for that sensor, i.e. to detect the presence of an identification feature that only that sensor, and no other sensor comprised in the brewer, detects. The brewer may be configured to adapt its operation based on which receptacle-type sensor that detects such presence. A sensor that detects the presence of an identification feature may send a signal to a controlling unit of the brewer, which controls the adaptation of an operation of the brewer based on that signal. The controlling unit may be a switch.

Alternatively, or additionally, the brewer may comprise a receptacle-type sensor configured to detect and distinguish between the presence of more than one type of identification feature, wherein each type of identification feature it can detect represents a certain type of beverage receptacle. The receptacle-type sensor is then configured to provide a signal to the brewer, such as to a controlling unit of the brewer, for example to a controlling unit of the brewer, which adapts an operation of the brewer in dependence of what signal it receives. In other words, the brewer identifies the type of identification feature that is detected by a receptacle-type sensor based on the type of signal it receives from the sensor, and adapts its operation accordingly.

The brewer may be of a type that brews coffee or a tea. The brewer may for example be a drip-filter coffee brewer. The brewer may comprise a water tank (i.e. water reservoir) into which water may be manually added by a user. The present disclosure does not exclude water being supplied directly via a water outlet connected to the brewer. The brewer may comprise a water dispensing unit for dispensing water into a container for infusion material, such as a filter holder for a holding a filter for ground coffee. The brewer may comprise a support for such a container, which may be integral with a beverage dispensing unit. A beverage dispensing unit may in other words both act as a support for the container and facilitate a flow of prepared beverage from the infusion container to a beverage receptacle. The brewer may comprise a means for controlling the flow of water from the tank to the water dispensing unit. Said means may comprise a water heating unit adapted to heat water in the water tank. The present disclosure does not exclude a coffee bean grinder being comprised in the brewer.

In a second aspect of the present disclosure, a brewer kit comprising the brewer described herein is provided, the kit further comprising a first type of beverage receptacle that is not thermally insulated and that comprises an identification feature. The first type of beverage receptacle may be a glass carafe (glass jug). The first type of beverage receptacle is suitable to be heated. It is thereby suitable that an identification feature is comprised in the first beverage receptacle, which when detected by a receptacle-type sensor of the brewer, leads to an adaptation of an operation performed by the brewer, said operation for example being activating a heating means of the brewer. The identification feature may be any of the identification features discussed is this disclosure.

The brewer kit may further comprise a second type of beverage receptacle that is thermally insulated and that optionally comprises an identification feature. The second type of beverage receptacle may be a thermos jug. The second type of beverage receptacle is not be suitable to be heated. It is thereby suitable that it either comprises no identification means, which results in the brewer not activating its heating means, or in some other way adapting its operation, or that is comprises an identification feature that differs from that of the first beverage receptacle, which when detected by a receptacle-type sensor of the brewer leads to an adaptation of an operation performed by the brewer that is suitable for that receptacle. The identification feature may be any of the identification features discussed is this disclosure.

Both the first type and the second type of beverage receptacle may comprise an identification feature. They may be different and distinguishable for at least one sensor comprised in the brewer, such that different operations are performed by the brewer depending on which identification feature is detected. The identification feature of the first type of beverage receptacle may be a magnet. The identification feature of the second type of beverage receptacle may then be a similar magnet, i.e. an identical or resembling magnet, being differently oriented. Differently oriented may mean located in a different position or turned differently, such as upside down compared to a magnet of the first type of beverage receptacle.

The first type and/or the second type of beverage receptacle may comprise an identification feature essentially having the shape of a ring or a cylinder. The ring may surround an opening of the receptacle through which beverage is to be introduced. The ring is then suitably present in a lid of the receptacle. It may alternatively have another symmetrical shape. An advantage of a symmetrical identification feature is that the receptacle may be inserted into or placed upon the brewer without having to be turned in a specific direction. Turning the receptacle around on the receiving portion does not affect the detection made by a sensor. The identification feature may be annular.

At least one of the first type and the second type of beverage receptacle may comprise an identification feature being located in a lid of a beverage receptacle. This is suitable in combination with a sensor present in a portion of the brewer being near the lid, such as a beverage dispensing unit or a filter holder support.

In a third aspect of the present disclosure, a method for controlling a brewer for preparing a beverage is provided, wherein the brewer comprises a receptacle receiving portion, and a receptacle-type sensor. The method is suitable to be implemented with a brewer or brewer kit as those disclosed herein. The method comprises the steps of:
detecting a presence of an identification feature of a beverage receptacle received by the receptacle receiving portion, said detection being performed by the receptacle-type sensor,
adapting an operation of the brewer upon detection of the identification feature by the receptacle-type sensor, said adapting being performed by the brewer.

The method may comprise activating a heating means of the brewer upon detection of an identification feature. The method may comprise activating a brewing program upon detection of an identification feature. The method may comprise adapting the flow of water from a water tank of the brewer and/or the flow of beverage into a beverage receptacle. The method may comprise a receptacle-type sensor detecting a presence of an identification feature of a beverage receptacle received by the receptacle receiving portion, the receptacle-type sensor providing a signal to a controlling unit of the brewer, and the controlling unit actuating an operation of the brewer based on said signal.

### BRIEF DESCRIPTION OF THE DRAWINGS

The present invention will be described further below by way of example and with reference to the enclosed drawings, in which

FIG. 1 shows one embodiment of a brewer, and a beverage receptacle being received by a receptacle receiving portion of the brewer,

FIG. 2 shows a cross-section of a beverage receptacle and receptacle receiving portion of the brewer of FIG. 1, and

FIG. 3 shows an exploded view of a beverage receptacle comprising an identification feature.

### DETAILED DESCRIPTION OF EMBODIMENTS

Embodiments of the present disclosure will now be described more fully hereinafter with reference to the accompanying figures. Like reference numbers refer to like elements throughout the description and figures.

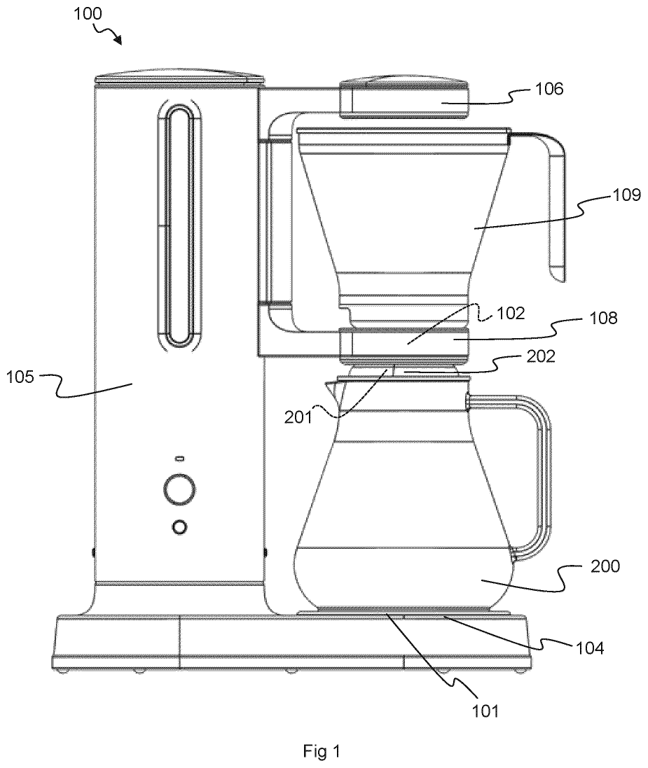

FIG. 1 shows an embodiment of a brewer 100 according to the invention and a beverage receptacle 200. The present brewer 100 comprises a water tank 105 in which water to be used to prepare a beverage is contained before being processed into a beverage. The water tank 105 has a tank lid which may be opened, which is one out of several ways for the tank to be designed to allow addition of water into it. The tank 105 is in this embodiment adapted to be manually filled with water by a user.

The brewer 100 of FIG. 1 further comprises a water dispensing unit 106. Water is provided from the water tank 105 to the water dispensing unit 106 via a water delivery pipe (not shown in the figure), from where it is dispensed into a holder 109 for a filter.

The filter holder 109, which may be provided separately from the brewer 100, and which could alternatively be another type of container for an infusion material, may as illustrated be supported by a beverage dispensing unit 108 of the brewer 100, which facilitates a flow of prepared beverage from the filter holder 109 into the beverage receptacle 200. The beverage dispensing unit 108 also acts as a filter holder support in this embodiment, and is in (FIG. 1) adapted such that a filter may be placed above a beverage receptacle 200 placed on a receptacle receiving portion 101 of the brewer 100. The beverage dispensing unit 108 may alternative be referred to as a container support.

FIG. 1 shows a beverage receptacle 200 being correctly placed for brewing, i.e. received by the receptacle receiving portion 101. FIG. 1 illustrates that a receptacle-type sensor 102 may be present in the beverage dispensing unit 108, and that an identification element 201 may be present in a lid 202 of the beverage receptacle 200.

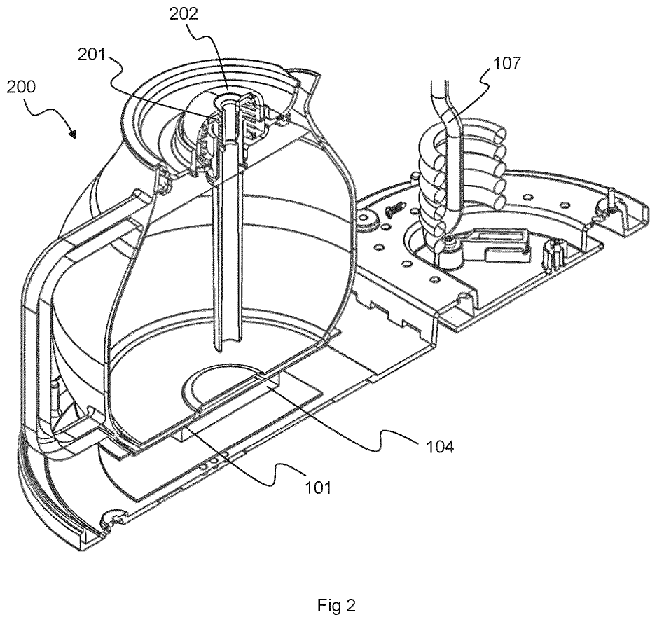

FIG. 2 shows a cross-section of a beverage receptacle 200 and the receptacle receiving portion 101 of the brewer 100 (as well as some other parts of the brewer 100, such as a support portion and heating element 107). Some features, such as the housing of the water tank 105 are not shown in FIG. 2.

The beverage receptacle 200 comprises a receptacle-type sensor 201 comprised in the lid 202 of the beverage receptacle 200. The present receptacle-type sensor 201 has the shape of a ring that surrounds a hole in the lid 202 through which beverage is intended to be introduced. The beverage receptacle 200 is placed such that is received by the receptacle receiving portion 101. It is thereby in a correct position for receiving beverage during a brew cycle. It is located on a heating means 104 in the form of a heating plate for heating the beverage receptacle 200. Seen in the figure is also a heating element 107, or water heating element, comprised in the brewer, being a means for heating water in the water tank 105 as well as controlling the flow of water from the water tank 105. The heating element 107 may be a boiler.

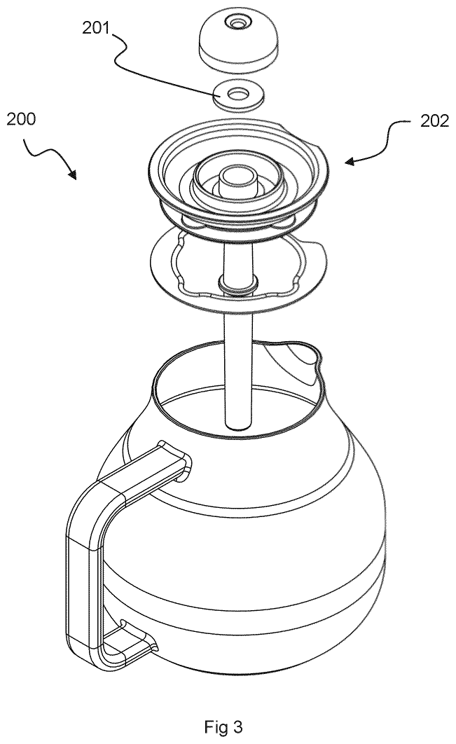

FIG. 3 shows a beverage receptacle 200 in an exploded view. The lid 202 comprises an opening through which beverage may be introduced into the receptacle 200. An identification feature 201 being a ring-shaped magnet is located such that it surround this opening, within the lid 202, when assembled correctly.

Now, in accordance with the present disclosure the brewer 100 is configured to adapt its operation based on the receptacle-type sensor 102 detecting the presence of the identification feature 201.

Typically, the brewer 100 may be configured to activate the heating means 104 only when an identification feature 201 is detected by a receptacle-type sensor 102. The brewer 100 may thus be suitable for use with at least two types of receptacles; one receptacle type that is suitable to be heated and another receptacle type that is unsuitable to be heated. For example, a non-thermally insulated glass carafe and a thermally insulated thermos jug, where only the glass carafe is suitable to be heated. The brewer 100 may be configured to activate the heating means 104 only when an identification feature 201 present in the non-thermally insulated glass carafe is detected.

Alternatively, or in addition, the brewer 100 may be configured to activate a brewing program that is suitable for a certain type of receptacle type. Thus, the brewer 100 may be configured to activate a brewing program that is associated with a detected identification feature 201 of a beverage receptacle 200.

The brewer 100 may as mentioned comprise a water dispensing unit 106 for dispensing water into a container 109 for infusion material. The brewer 100 may in addition comprise means for controlling the flow of water from said dispenser 106 and said means may be configured to induce a flow of water only when an identification feature 201 is detected by a receptacle-type sensor 102.

The means for controlling the flow of water from the dispenser 106 may be an undepicted controllable water valve, or may be control means that controls the water heating element 107, or may be a controllable water pump connected in series with the water heating element 107.

As mentioned, the receptacle-type sensor 102 may be configured to detect the presence of an identification feature 201 being a magnet. The receptacle-type sensor 102 may in addition be configured to detect the orientation of the identification feature 201. Thus, the same type of magnet, but differently orientated, may be used as an identification feature 201 for a glass carafe and for a thermos jug. The receptacle-type sensor 102 may be configured to distinguish between different receptacle types based on the presence, and/or the orientation, of identification features 201 of the receptacles.

In the present embodiment, the receptacle-type sensor 102 comprises a Hall effect sensor.

In other embodiments, the receptacle-type sensor 102 may be configured to detect the presence of an identification feature 201 being defined by at least one of the shape and the material of the beverage receptacle 200. For example, the beverage receptacle 200, or a portion there of, may be made of metal and the receptacle-type sensor 102 may be configured to detect the presence of metal. The receptacle-type sensor 102 may thus be configured to distinguish between different receptacle types based on the presence, and/or the orientation, of a metal receptacle or a receptacle that comprises a metal portion.

In an undepicted embodiment, the brewer may comprise at least two receptacle-type sensors 102 each being configured to detect a presence of at least one type of identification feature 201 that is unique for that sensor 102. Such a brewer 100 may be configured to adapt its operation based on which receptacle-type sensor 102 that detects such presence. For example, the present beverage dispensing unit 108 may comprise an inner receptacle-type sensor and an outer receptacle-type sensor (not shown). Correspondingly, the receptacles to be used with such a brewer may comprise inner and outer identification features 201. For example, there may an outer ring-shaped magnet that forms the outer receptacle-type sensor and an inner ring-shaped magnet that forms the inner receptacle-type sensor. The inner and outer receptacle-type sensors (typically Hall effect sensors) may be positioned to detect the separate inner and outer ring-shaped magnets.

The brewer 100 may comprise a receptacle-type sensor 102 that is configured to detect a presence of at least two different types of identification features 201. The brewer 100 may be configured to adapt its operation based on what type of identification feature 201 that is detected by the receptacle-type sensor 102. For example, the above-mentioned glass carafe and thermos jug may both comprise identification features 201 in the form of magnets, but one of said magnets may be stronger than the other magnet. In such an embodiment, a Hall effect sensor 102 may be configured to detect both magnets and based on the different strengths the brewer 100 may distinguish between the glass carafe and the thermos jug. Thus, the brewer 100 may activate the water heating element 107 independently of which one of the receptacle types that is detected, but only activate the heating means 104 if the glass carafe is detected.

The brewer 100 may comprise an undepicted controlling unit that is connected to the receptacle-type sensor 102 and that may active the water heating element 107 and the heating means 104.

FIG. 1 may also be said to shown a brewer kit that comprises the brewer 100 a first type of beverage receptacle 200 that is not thermally insulated and that comprises an identification feature 201. Such a brewer kit may comprise a second type of beverage receptacle 200 that is thermally insulated and that optionally comprises an identification feature 201. The first type of beverage receptacle may be a glass carafe and the second type of beverage receptacle may be a thermos jug.

As has been mentioned, the both the first type and the second type of beverage receptacle may comprise an identification feature. The identification feature 201 of the first type of beverage receptacle may be a magnet and the identification feature 201 of the second type of beverage receptacle is a similar magnet being differently oriented. For example, the magnets may be oriented with their polarities differently oriented.

A method for controlling a brewer, for example the above-described brewer 100, may comprise a receptacle-type sensor 102 detecting a presence of an identification feature 201 of a beverage receptacle 200 received by the receptacle receiving portion 101, and
the brewer adapting its operation upon detection of an identification feature 201 by the receptacle-type sensor 102. The adapting may be performed by a controlling unit of the brewer 100.

Modifications and other variants of the described aspects and embodiments will come to mind to one skilled in the art having benefit of the teachings presented in the foregoing description and associated drawings. Therefore, it is to be understood that the embodiments are not limited to the specific example aspects and embodiments described in this disclosure and that modifications and other variants are intended to be included within the scope of this disclosure. Furthermore, although specific terms may be employed herein, they are used in a generic and descriptive sense only and not for purposes of limitation. Therefore, a person skilled in the art would recognize numerous variations to the described embodiments that would still fall within the scope of the appended claims.

As used herein, the terms “comprise/comprises” or “include/includes” do not exclude the presence of other elements or steps. Furthermore, although individual features may be included in different claims (or embodiments), these may possibly advantageously be combined, and the inclusion of different claims (or embodiments) does not imply that a combination of features is not feasible and/or advantageous. In addition, singular references do not exclude a plurality. Finally, reference signs in the claims are provided merely as a clarifying example and should not be construed as limiting the scope of the claims in any way.

1. A brewer for preparing a beverage, the brewer comprising
a receptacle receiving portion configured to receive a beverage receptacle, and
a receptacle-type sensor,
wherein the receptacle-type sensor is configured to detect a presence of an identification feature of a beverage receptacle received by the receptacle receiving portion, and
wherein the brewer is configured to adapt its operation when an identification feature is detected by a receptacle-type sensor.

2. The brewer according to claim 1, wherein the brewer comprises a heating means configured to heat a beverage receptacle received by the receptacle receiving portion, and wherein the brewer is configured to adapt its operation of the heating means when an identification feature is detected by a receptacle-type sensor.

3. The brewer according to claim 1, wherein the brewer is configured to activate a brewing program associated with a detected identification feature of a beverage receptacle.

4. The brewer according to claim 1, wherein the brewer comprises a water dispensing unit for dispensing water into a container for infusion material, and a means for controlling the flow of water from said water dispensing unit, and wherein said means for controlling the flow of water is configured to induce a flow of water only when an identification feature is detected by a receptacle-type sensor.

5. The brewer according to claim 1, wherein the receptacle-type sensor is configured to detect the presence, and optionally the orientation, of an identification feature being a magnet.

6. The brewer according to claim 1, wherein the receptacle-type sensor comprises a Hall effect sensor.

7. The brewer according to claim 1, wherein the receptacle-type sensor is configured to detect the presence of an identification feature being defined by at least one of the shape and the material of the beverage receptacle.

8. The brewer according to claim 1, comprising a beverage dispensing unit configured to facilitate dispensing a prepared beverage into a beverage receptacle received by the receptacle receiving portion wherein a receptacle-type sensor is located in the beverage dispensing unit.

9. The brewer according to claim 1, comprising at least two receptacle-type sensors each being configured to detect a presence of at least one type of identification feature unique for that sensor, wherein the brewer is configured to adapt its operation based on which receptacle-type sensor that detects such presence.

10. The brewer according to claim 1, comprising a receptacle-type sensor configured to detect a presence of at least two different types of identification features, and wherein the brewer is configured to adapt its operation based on what type of identification feature is detected by the receptacle-type sensor.

11. The brewer according to claim 1, comprising a water tank into which water may be manually added by a user, a water dispensing unit for dispensing water into a container for infusion material, a water heater and optionally a beverage dispensing unit for supporting such a container

12. A brewer kit comprising the brewer according claim 1 and a first type of beverage receptacle that is not thermally insulated and that comprises an identification feature.

13. The brewer kit according to claim 12 further comprising a second type of beverage receptacle that is thermally insulated and that optionally comprises an identification feature.

14. The brewer kit according to claim 13, wherein both the first type and the second type of beverage receptacle comprises an identification feature, and wherein the identification feature of the first type of beverage receptacle is a magnet and the identification feature of the second type of beverage receptacle is a similar magnet being differently oriented.

15. The brewer kit according to claim 13, wherein at least one of the first type and the second type of beverage receptacle comprises an identification feature essentially having the shape of a ring or cylinder that surrounds an opening of said receptacle through which beverage is to be introduced.

16. The brewer kit according to claim 13, wherein at least one of the first type and the second type of beverage receptacle comprises an identification feature being located in a lid of said beverage receptacle.

17. A method for controlling a brewer for preparing a beverage, wherein the brewer comprises a receptacle receiving portion, and a receptacle-type sensor, wherein the method comprises:
the receptacle-type sensor detecting a presence of an identification feature of a beverage receptacle received by the receptacle receiving portion, and
the brewer adapting its operation upon detection of an identification feature by the receptacle-type sensor.
